(19) United States
(12) Patent Application Publication
(10) Pub. No.: US 2016/0199848 A1
(43) Pub. Date: Jul. 14, 2016

(54) Shredder machine for waste material

(71) Applicant: FOR REC SRL, SANTA GIUSTINA IN COLLE (PD) (IT)

(72) Inventor: PIERANGELO TONDELLI, SANTA GIUSTINA IN COLLE (PD) (IT)

(21) Appl. No.: 14/864,869

(22) Filed: Sep. 25, 2015

(30) Foreign Application Priority Data
Sep. 25, 2014 (IT) TV2014A000143

(51) Int. Cl. B02C 18/18; B02C 18/00

(52) U.S. Cl. CPC B02C 18/18; B02C 18/0092; B02C 2018/188

(57) ABSTRACT

A shredder machine (MC) for Waste material is disclosed. It comprises a table (60) equipped with fixed knives (22, 24); a shaft (30a) rotatably mounted on the table and equipped with an array of rotating knives (20a) which are axially spaced and radially projecting from the shaft: wherein the rotary knives have a face (36a) adjacent to, and adapted to cooperate with, a fixed knife (24) for cutting the material.

To prevent axial imbalance of forces, the machine comprises a pair of fixed knives (22, 24) where one (22) is adjacent to and adapted to cooperate with, a face (28a) of a rotating knife and the other (24) is adjacent to, and adapted to cooperate with, the opposite face (36a) of the same rotating knife.

The invention relates in general to a shredder, e.g. for waste materials such as garbage, residues, or scrap or recyclable materials.

A machine of this type is described in WO 97/10057. On a fixed table there are mounted two rotating shafts equipped with a row of knives placed radially along the axis and spaced apart by a constant measure one from the other. Adjacent to a face of each rotating knife there is a fixed knife mounted on the table, while the other face of the rotating knife has in front of it an empty space, through which the shredded material falls below the table. Therefore, the material to be chipped is hooked by the rotary knife and sliced against the adjacent fixed knife, and the comminuted parts fall by gravity and are collected below the table.

Since all the knives of a shaft cut the material on the same face, a huge axial thrust is generated on the shaft, given by the equally-orientated force reactions of the material on the fixed knives. That's why the shafts have to be supported with expensive and bulky thrust-bearings, and both the shaft and the knives must be oversized, which increases the production and maintenance costs and the weight of the machine.

The fixed knives cooperating with a rotating knife are L- or Z-shaped, all lie on a plan at the top of the table and because they are aligned orthogonally to the shaft axis they can be supported by vertical metal sheets also orthogonal to the shaft axis. This structure of vertical metal sheets, although economic, makes another disposition for the fixed knives impossible.

It is desired to improve this state of the art, in particular with a shredder simpler to build.

It is then proposed a shredder for waste material comprising:
a table equipped with fixed knives;
a shaft rotatably mounted on the table and equipped with an array of rotating knives which are axially spaced and radially projecting from the shaft,
wherein the rotary knives have a face adjacent to, and adapted to cooperate with, a fixed knife for cutting the material, further comprising a pair of fixed knives wherein one is adjacent to and adapted to cooperate with a face of a rotating knife and the other is adjacent to and adapted to cooperate with, the opposite face of the same rotating knife.

In this way the reaction forces on the fixed knives of the pair are balanced, and the axial thrust can be canceled out.

With face it is meant the surface of the rotating knife that is orthogonal to the axis of the shaft it is mounted on, wherein the two opposite faces of the knife delimit its thickness measured along the axis of the shaft.

Advantageous variants are defined in the dependent claims, usable alone or in combination between each other or with what is described here.

The following description relates to a preferred embodiment of shredder and further highlights advantages of its by reference to the accompanying drawings in which:

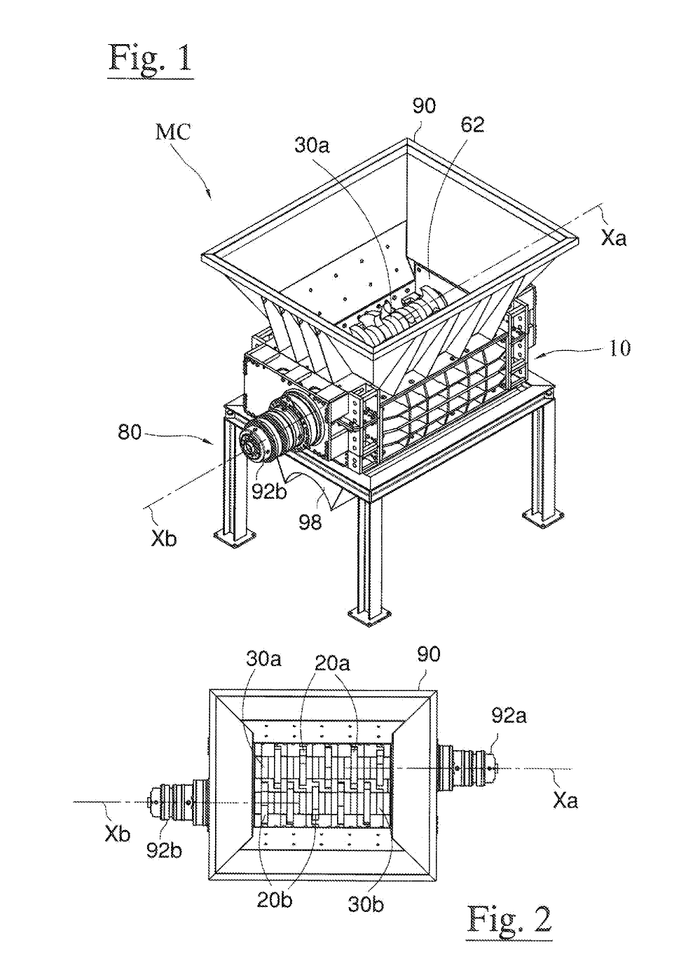

FIG. 1 shows a three dimensional view of a shredder;

FIG. 2 shows a top view of the shredder of FIG. 1;

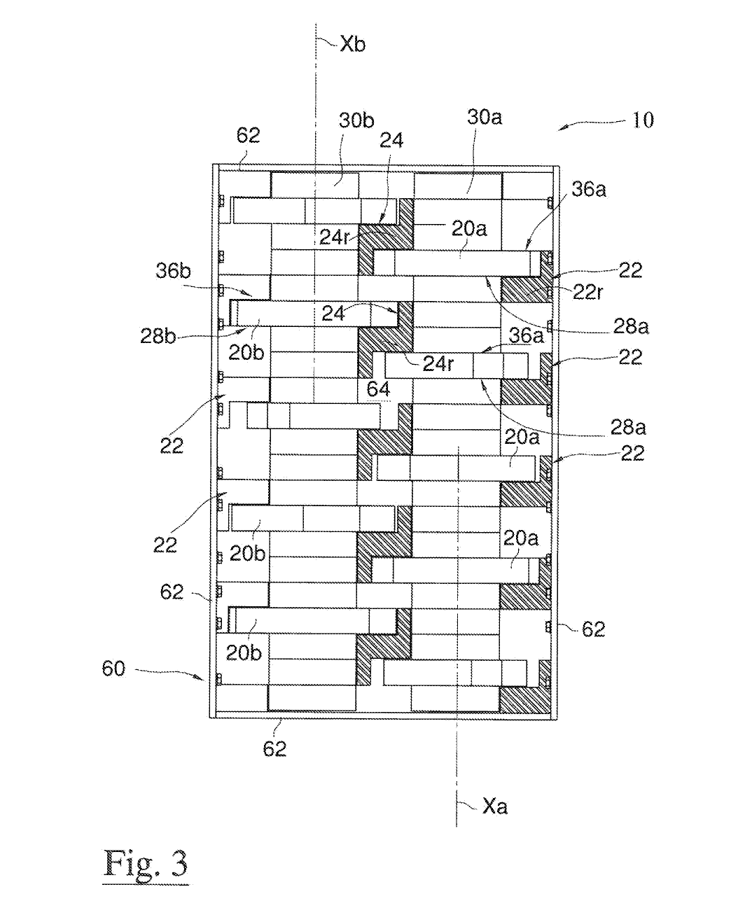

FIG. 3 shows an enlarged view of FIG. 2;

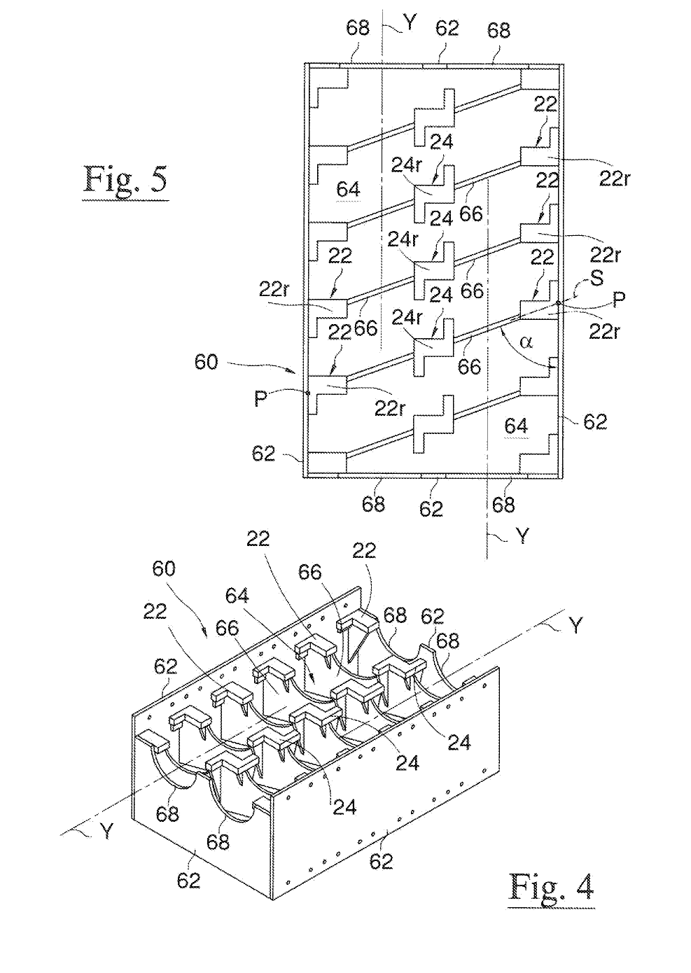

FIG. 4 shows a three dimensional view of a table for fixed knives of the shredder of FIG. 1;

FIG. 5 shows a top view of the table of FIG. 4.

In the figures same numerals indicate same or similar parts, and the shredder is described as in use. The numbers for simplicity indicate only some components so as not to crowd the drawings.

A shredder MC is formed (FIG. 1) by a supporting frame 80, with e.g. four vertical legs, a shredding unit 10 and a hopper 90 for supplying material to the unit 10.

The material is loaded into the hopper 90, comminuted inside the unit 10 and unloaded by gravity from a funnel 98 placed under the unit 10.

The unit 10 comprises two shafts 30a, 30b with parallel axes indicated respectively by Xa, Xb and connected e.g. with two external heads 92a, 92b. In the following we will use the suffixes “a” and “b” for components respectively related to the two shafts 30a, 30b and it will be sufficient to describe the system for the single shaft 30a.

The shaft 30a is equipped with various knives 20a integrally arranged along the axis Xa and spaced apart by a certain distance, e.g. a constant distance. The knives 20a have known form, e.g. of a disk, a spoke or a hammer, and exhibit two opposite faces 36a, 28a, which are substantially mutually parallel and orthogonal to axis Xa. The faces 36a, 28a delimit the thickness of the knives 20a.

Internally to the unit 10, which rotatably supports the shaft 30, there is a structure or table 60 (FIGS. 4 and 5), which supports fixed knives 22, 24 which cooperate with the knives 20a, 20b.

The table 60 has a box-shaped frame, e.g. parallelepiped with a square or rectangular base, with side walls 62 which delimit a pass-through cavity 64. Inside the cavity 64 is a plurality of metal sheets or baffles 66 on top of which are placed, lying in the same plane but not necessarily, the fixed knives 22, 24, Each metal sheet 66 comprises two lodgements 68 for a shaft, in the form e.g. of a semicircular recess. The lodgements 68 of each metal sheet 66 are aligned with one another and equal to those of the adjacent metal sheets 66, so that overall a seat is formed along an imaginary axis Y in which to lay the shaft (whose axis Xa, Xb will be parallel to. and can be coincident with, the axis Y).

With reference to FIG. 3, it can be seen the arrangement of the knives 22, 24 (better shown by darkening them with a hatch). Around each rotating knife 20a there are two fixed knives 22, 24. The knife 22 has L-shaped plan, is on the perimeter of the table 60 and is adjacent to the face 28a, while the knife 24 has Z-shaped plan, is adjacent to the face 36a and is at the center of the table 60 or within the cavity 64 when there are more than two shafts. The knives 22, 24 have therefore a straight segment 22r, 24r, and are arranged so that such segment 22r, 24r is orthogonal to the axis Xa of the shaft 30a. The distance between the segments 22r, 24r of two fixed knives 22, 24 adjacent to a same rotating knife 20a is about the thickness of the knife 20a itself Then, the fixed knives 22, 24 are arranged aligned with each other and along an axis parallel to the axis Xa or Y.

A rotary knife 20a can push the material against the edges of the fixed knifes 22, 24 (i.e. of the segments 22r, 240 in correspondence of the faces 36a, 28a, which by rotating cut the material that falls downwards through the empty spaces present between the fixed knives 22, 24.

It is thus evident that the fixed blades 22, 24 relative to the same shaft 30a are in opposite position with respect to the axis Xa of that shaft 30a (one at the center of the table 60 and one on the perimeter). Therefore the material strikes, from above or from below, the knife 22 or the knife 24 according to the direction of rotation of the shaft 30a (the shaft 30a or 30b e.g. reverses its motion for programmed cycles in order to move the material in the hopper 90 and prevent clogging; it can reverse the motion also in case of overload).

The advantage of this configuration for the table 60 is that during operation the resultant of the axial thrust due to the reaction force on the fixed knives 22, 24 is practically null, because the force reactions on the fixed knives balance. Thus the supports or hearings of the shaft 30a, 30b can he less reinforced and designed for lower loads.

Note that the surface of the empty spaces between the fixed and rotating knives, and therefore the sizes of the shredded product, can be varied by changing the arrangement of the fixed knives 22, 24, in particularly by varying their relative distance.

In any case not only additional space is left in front of a fixed knife 22 or 24 for unloading the shredded material, but the reaction force on the fixed knives 22, 24 is even better distributed on the shaft.

Another advantage is that a uniform wear occurs on the two sides of the blade of a rotating knife thereby halving consumption and doubling the working life length thereof.

Also note that a knife 24 is common to the two blades 20a, 20b.

The arrangement of the fixed knives 22, 24, in which the segments 22r, 24r are aligned orthogonally to the axes Xa, Xb but not necessarily, is simply advantageously obtained by some inclination of the metal sheets 66 with respect to such axes and/or to two parallel walls 62 (FIG. 5). Each metal sheet 66 supports a fixed knife 22, 24 adjacent to, and cooperating with, at least two different knives 20a of a same shaft. In particular, each metal sheet 66 supports at least the fixed blades relative to the faces 36a, 28a directly facing two different and consecutive knives 20a.

Another advantage is that the inclination of the metal sheets 66 also holds with respect to the fixed knives 22, 24, which are therefore supported by a larger section of metal sheet 66. Thus larger fixed knives for with greater blade) can be supported, the size of the table 60 or the thickness of the sheet 66 being equal.

Another advantage is that the transverse metal sheets 66 can be thinner since the axial load they bear is balanced.

The inclined metal sheets 66 can also be used, however, with fixed knives of known arrangements.

The acute angle α (see FIG. 5), formed by a metal sheet 66 relative to the wall 62 from which it extends, can vary between 89 degrees and 45 degrees, preferably between 45 degrees and 75 degrees, even more preferably being 60 degrees. The angle can be defined in relation to the axial distance between the fixed knives, given by the thickness of the rotating knives plus the adjacent empty space. These values hold for substantially straight metal sheets or baffles. The above also holds if one considers an acute angle a formed by a metal sheet 66 relative to the axis of a shaft 30a or 30b.

### OPTIONS

The shredder may have many variants, to be used alone or in combination with each other and/or with what has been already described. E.g. there can be
a different number of rotating shafts and/or rotating knives for each shaft. Note the modular construction of the table 60 for each shaft (FIG. 5): to accommodate multiple shafts one just need to lengthen the walls 62 and the metal sheets 66, and to add additional fixed knives 22, 24;
different forms for the fixed blades; e.g. linear without contrast on the tangent of the blade, oval-shaped so as to have a point tangent to the blade and a progressive cut, or diamond-shaped in order to have a progressive cut
rotating knives placed radially along the axis of a shaft and spaced by a variable and/or constant distance from each other;
rotating shafts with axes not parallel;
different inclination for each of the metal sheets 66, e.g. not all with the same inclination;
metal sheets or baffles 66 being not straight but with different developments, e.g. curvilinear or segmented. The said value of the angle a can be referred then to the “average” direction of the development of the baffles or thee metal sheets 66. Or the angle α corresponds to the inclination, relative to the walls 62 and/or to the axis of a shaft or in general to the perimeter of the table 60, of the plane S that passes through the connection or attachment points P of the baffles or metal sheets 66, rectilinear or not, to the walls 62. The points P and the plane S are indicated in FIG. 5;
the metal sheets or baffles 66 can be fabricated in a single piece or as union of minor pieces.

1. Shredder machine (MC) for waste material comprising
a table (60) equipped with fixed knives (22, 24);
a shaft (30a) rotatably mounted on the table and equipped with an array of rotating knives (20a) which are axially spaced and radially projecting from the shaft;
wherein the rotary knives have a face (36a) adjacent to, and adapted to cooperate with, a fixed knife (24) for cutting the material,
further comprising a pair of fixed knives (22, 24)
where one (22) is adjacent to and adapted to cooperate with, a face (28a) of a rotating knife
and the other (24) is adjacent to, and adapted to cooperate with the opposite face (36a) of the same rotating knife.

2. Machine according to claim 1, comprising a first and second shaft (30a, 30b) both defined as in claim 1, and wherein a knife (24) of the pair is adjacent to and adapted to cooperate with, a face of a rotating knife on the first shaft and with a face of a rotating knife on the second shaft.

3. Machine according to claim 2, wherein the said faces of the rotary knives present on the first and second shafts are opposite to each other.

4. Machine according to any one of the preceding claims, wherein the pair of fixed knives is supported by a wall (66) of the table that is inclined with respect to the axes of the shafts.

5. Machine according to any one of the preceding claims, wherein the pair of fixed knives is supported by a wall (66) of the table that is inclined with respect to the side-walls of the table from which the wall (66) extends.

6. Machine according to any one of the preceding claims, wherein the pair of fixed knives is supported by a wall (66) of the table whose attachment points (P) to the table belong to a plane (S) that is inclined with respect to the side-walls (62) of the table from which the wall (66) extends.

7. Machine according to claim 4 or 5 or 6, wherein the acute angle (α) relative to the inclination of said wall (66) or plane (S) is between 89 degrees and 45 degrees, preferably between 45 degrees and 75 degrees, still more preferably being 60 degrees.

8. Machine according to any one of the preceding claims, wherein the table (60) comprises a parallelepiped box-shaped frame, with square or rectangular base, with side-walls (62) delimiting a pass-through cavity (64) inside which there is said inclined wall.

9. Machine according to any one of claims 4 to 8, wherein said inclined wall (66) comprises a housing (68) for a shaft, e.g. in the form of a semicircular recess.

10. Machine according to any one of the preceding claims, comprising a plurality of pairs of fixed knives as defined in claim 1, the pairs being aligned along an axis.
